(19) United States
(12) Patent Application Publication
(10) Pub. No.: US 2005/0114527 A1
(43) Pub. Date: May 26, 2005

(54) System and method for personal communication over a global computer network

(76) Inventors: Michael Robert Hankey, Towson, MD (US); Robert Garner, Miami Beach, FL (US); Ernesto Morales, Miami Beach, FL (US); Abe Smilowitz, Miami Beach, FL (US); Brian Hoffman, Towson, MD (US)

Correspondence Address: Kevin Lynn Wildenstein;Southwest Intellectual Property Services, LLC, Suite 8, 6700-B Jefferson NE, Albuquqerque, NM, 87109, US

(21) Appl. No.: 10/961,852

(22) Filed: Oct. 8, 2004

Related U.S. Application Data
(60) Provisional application No. 60/509,778, filed on Oct. 8, 2003.

(51) Int. Cl. G06F 15/16

(52) U.S. Cl. 709/228

(57) ABSTRACT

A system and method for facilitating and enhancing substantially real-time interpersonal communication over a network such as the Internet, the method comprising at least the steps of facilitating data communication between at least a primary user and at least a secondary user, both the primary user and each secondary user being in communication with the network through a computing system, the data communication including at least communication of video data, audio date or text data. In one embodiment, the present invention is a computer application directed towards interpersonal communications which allows a user to access, communicate and log in to a pre-determined Internet web site. Once logged in, the application allows a user to view other users of the application, allows a user to create a new room or electronic meeting area, join an existing room or electronic meeting area created by another user, or utilize an online, real time video, audio and/or text conferencing program to communicate with one or more other users on the same web site. The present invention does not require the user to download any specialized software, platform specific software or application specific software.

### REFERENCE TO RELATED DOCUMENTS

This invention claims priority to, and the benefit of, U.S. Provisional Patent Application Ser. No. 60/509,778, entitled “System and Method for Personal Communication Over a Global Computer Network”, filed Oct. 8, 2003, the entire contents of which are hereby incorporated by reference.

### TECHNICAL FIELD OF INVENTION

The present invention relates generally to one or more integrated software applications coupled to one or more computers which are available over a global computer network for text and/or video-based personal communication between users of the computers, to user interfaces and content for real-time communication, and more specifically, to an integrated software system and method available over or accessible through the Internet which allows users to communicate in a multi-user dating or matchmaking community environment in real-time.

### BACKGROUND OF THE INVENTION

Computer users now have the capability, through advancement in the art, of communicating with other users over a computer network such as the Internet. Typically, in order to achieve such communication, each person communicating must have a computing means adapted to access a computer network (such as a personal computer coupled to the Internet, for example), a video transceiver coupled to the computing means (such as a web cam, for example) and an audio transceiver coupled to the computing means (such as a microphone and speakers, for example).

Various audio and video conferencing software programs exist on the Internet which allow users to achieve such communication (the terms “application”, “application software”, “software”, “program”, “algorithm” and “subroutine”, whether used as singular or plural, are all used interchangeably throughout this invention to refer to a software program). A representative example of such applications include ICU (“I see you”), MSN Messenger and Yahoo Messenger. However, these applications are stand-alone applications, which means that each user must first download the application or program from a remote computer for storage on the user's computer system. Next, the user must execute (or, run) the applications on their computer system. When these applications are executed on a user's computer system, the application software connects to a network such as the Internet and directs the user's computer system to a remotely-located dedicated computer which only allows the user to communicate with other users who have similarly downloaded and operated the same application as the user. Such applications do not foster a user-based community because of the proprietary nature of the software (e.g., every user has to have downloaded the same application software in order to communicate). Moreover, such applications do not feature an online dating service capable of providing real-time communication between potential and actual dating partners. While a user may view (or, see) and hear other users on these applications, the users cannot directly meet them because typically, a user must first know the other users of the system in order to initiate any type of communication. Finally, Internet web sites which promote online dating services typically only offer text based instant messaging; conversely, while some instant messenger applications have added video and audio capabilities to their software packages, these applications do not provide a dating forum (or, single Internet web site) of readily available users.

The popularity of the Internet, wireless technologies and satellite-based technologies has enhanced the way people communicate with each other by allowing users quick and easy access to a virtually endless sea of communication methods. Any user of these technologies may now contact another person with greater or lesser immediacy using various media, including the World Wide Web, electronic mail (email), cellular, satellite or Internet telephony, video conferencing, voice over IP, and instant text messaging. These methods allow people to stay in touch with each other around the globe, and to access information on many subjects.

A community-based Internet web site requires sufficient communication channels or bandwidth to allow one or more users to gain the experience that other persons are physically in the same room as the user while accessing this web site. The phrase “community-based” refers to an Internet web site which caters to a group of people with common interests. The goal of a community-based Internet web site is to offer a place on the Internet where users can gather to meet and talk about their common interests with other users. Conventional communication channels for this type of site include electronic message boards, email and text based chat.

The lack of sufficient communication channels or communication bandwidth can be a problem inside of any community-based website. For example, a user can communicate on a global computer network previously through electronic mail, bulletin boards accessible to the public, public message boards and sometimes text-based instant messaging. However, with the exception of the text chat or instant messaging functions available on the Internet, all other forms of communications over a global computer network are not substantially real-time or live. This means, for example, that a first user using conventional instant messaging text chat writes and sends a message to a second user and then must wait for the second user to physically type the response on their computer system and send it back to the first user. This type of communication is slow, and also lacks the personal feel that comes with a live or real time video and/or audio transmission. If the purpose of the online meeting site is to meet other people for romantic, interpersonal or business purposes, these added communication obstacles break the personal barriers associated with traditional Internet communication protocols.

Internet based audio and/or video conferencing is not new, but the prior technology has several distinct disadvantages. For example, ICU (http://www.icuii.com) created a stand-alone video and audio based chat application, but as noted previously, this proprietary software must be downloaded by each user in order to use the communication protocol. As another example, numerous software packages such as ‘See you see me’ (http://www.cuseeme.com) and ‘Microsoft Instant Messenger’ (http://www.msn.com) also provide live video-audio conference capabilities. However, these applications fail to bring a community of users together for a common goal (such as, for example, interpersonal communication or online dating) at one location on an Internet web site which would attract and allow all participants to all communicate with each other either at the same time or, on a one-on-one basis through a personal communication channel, in real-time or substantially instantly. Instead, in order to effectively use these other prior art technologies, a user must first know the other user names or identifications available on the system before the user can attempt to communicate with the other users. This may be an option amongst users who are family members or longtime friends, but is not a good option for users who are seeking to meet new people, to date new people or who want to personally interact with new people. And again, as mentioned previously, these applications are proprietary in nature, requiring all users to have first downloaded and then execute the same proprietary software. Finally, communication is virtually impossible to achieve unless one users knows the screen name or similar identifier of another user. While these existing applications provide a location for video conferencing with family members, close friends or some known user, they do not help in meeting new people.

Additionally, prior video/audio communication applications have failed to provide a forum of users to easily meet and communicate with each other. These applications have been traditionally based on “peer-to-peer” (e.g., one to one) technology. They do not provide a facility for a centralized meeting place specifically designed for the purpose of dating or communicating with a number of users over a network for the creation or enhancement of interpersonal communication.

In sum, there is a lack of the capability to conduct real time, substantially live, personal audio and video communication in a predefined, single, computing site over a global computer network such as the Internet. Users of global computer networks desire a “one stop” electronic meeting place where people of similar interests, genre, age groups and geographic locations can meet, talk and see each other in a live or real-time format, all without the problems associated with downloading and using solely proprietary software which must be executed by all users of such proprietary software.

The present invention solves these problems by providing the ability to communicate in a real-time fashion in a single forum which fosters a community-based spirit. The present invention enhances the communication capability over a global computer network such as the Internet, and in one preferred embodiment, is directed towards online dating and interpersonal communication. In this embodiment, the present invention offers features and functionality tailored specifically towards allowing a user to meet, view and communicate with others who are also interested in starting, developing and/or enhancing a interpersonal relationship.

### SUMMARY OF THE INVENTION

The following summary of the invention is provided to facilitate an understanding of some of the innovative features unique to the present invention, and is not intended to be a full description of variations that may be apparent to those of skill in the art. A full appreciation of the various aspects of the invention can be gained from the entire specification, claims, drawings, and abstract taken as a whole.

The present invention is a system and method for personal communication over a global computer network. In one embodiment, the present invention is an application directed towards interpersonal communications which allows a user to access, communicate and log in to a pre-determined Internet web site. Once logged in, the application allows a user to view other users of the application, allows a user to create a new room or electronic meeting area, join an existing room or electronic meeting area created by another user, or utilize an online, real time video and audio conferencing program to communicate with one or more other users on the same web site. The present invention does not require the user to download any specialized software, platform specific software or application specific software.

The present invention includes a system and method for facilitating and enhancing substantially real-time interpersonal communication over a network such as the Internet, the method comprising at least the steps of facilitating data communication between at least a primary user and at least a secondary user, both the primary user and each secondary user being in communication with the network through a computing system, the data communication including at least communication of video data, audio date or text data. In one embodiment, the present invention is one or more computer applications directed towards interpersonal communications which allows a user to access, communicate and log in to a pre-determined Internet web site. Once logged in, the application allows a user to view other users of the application, allows a user to create a new room or electronic meeting area, join an existing room or electronic meeting area created by another user, or utilize an online, real time video, audio and/or text conferencing program to communicate with one or more other users on the same web site. The present invention does not require the user to download any specialized software, platform specific software or application specific software. Thus, in one preferred embodiment, the system comprises at least one flash communication server, at least one webserver and one database server, all in communication with each other, and adapted for facilitating and enhancing substantially real-time interpersonal communication over a network such as the Internet. Those of skill in the art will recognize that the present invention may be accomplished on a single computing platform, or through a plurality of computing platforms communicating amongst themselves. In the preferred embodiment, a distributed computing platform is envisioned which will result in an optimized network architecture system.

The present invention provides the ability to allow the user to host the application within the same web site which means that users will never have to leave the web site in order to “run” or execute the present invention. Additionally, the present invention provides a centralized meeting place for those interested in real time dating and/or interpersonal communication over a computer network. The present invention also allows users to communicate with others on the computer network who are accessing the web site hosting the application, or to communicate with selected users in public or private virtual rooms. From within any room, the present invention also allows a user to view other users profile (e.g., personal information), picture(s), and also optionally send an electronic mail message to one or more other secondary users of the present invention.

The present invention solves the problem of the lack of real time communication over a computer network specifically adapted to interpersonal or dating communication. The results achieved by the present invention include a web based communication tool that supports a dynamic video conferencing environment for multiple users. With this invention, users of Internet dating sites can now see and hear other users in real time. The invention provides a forum for meeting people on-line and a communication channel for seeing and hearing them. In addition, achievements of the application include private room support so that two or more users can privately videoconference as well. These achievements take place within the context of the dating site so that each user never has to leave the web page to use the application.

The novel features of the present invention will become apparent to those of skill in the art upon examination of the following detailed description of the preferred embodiment or can be learned by practice of the present invention. It should be understood, however, that the detailed description of the preferred embodiment and the specific examples presented, while indicating certain embodiments of the present invention, are provided for illustration purposes only because various changes and modifications within the spirit and scope of the invention will become apparent to those of skill in the art from the detailed description, drawings and claims that follow.

### BRIEF DESCRIPTION OF THE DRAWINGS

The accompanying figures further illustrate the present invention and, together with the detailed description of the preferred embodiment, assists to explain the general principles according to the present invention.

The present invention consists of at least one client software program and at least one server software program which enable a user on the predetermined web site to broadcast video and/or audio information to a server, which in turn, simultaneously rebroadcasts the information to other users who are logged in to the predetermined web site.

FIG. 1 is a representative process flowchart featuring a home page interface according to one aspect of the present invention;

FIG. 2a is a representative process flowchart featuring a Primary User Information interface according to one aspect of the present invention;

FIG. 2b is a representative graphical user interface according to one aspect of the present invention;

FIG. 3 is a representative process flowchart featuring a Primary User Menu interface according to one aspect of the present invention;

FIG. 4 is a representative process flowchart featuring a Contacts interface according to one aspect of the present invention;

FIG. 5 is a representative process flowchart of featuring a New Users interface according to one aspect of the present invention;

FIG. 6 is a representative process flowchart featuring an Audio/Video interface according to one aspect of the present invention;

FIG. 7 is a representative process flowchart featuring a Room List Application interface according to one aspect of the present invention;

FIG. 7a is a representative graphical user interface according to one aspect of the present invention;

FIG. 8 is a representative process flowchart featuring a Flash Video/Audio Application interface according to one aspect of the present invention;

FIG. 8a is a representative graphical user interface according to one aspect of the present invention; and

FIG. 9 is a representative process flowchart featuring an Action Menu interface according to one aspect of the present invention.

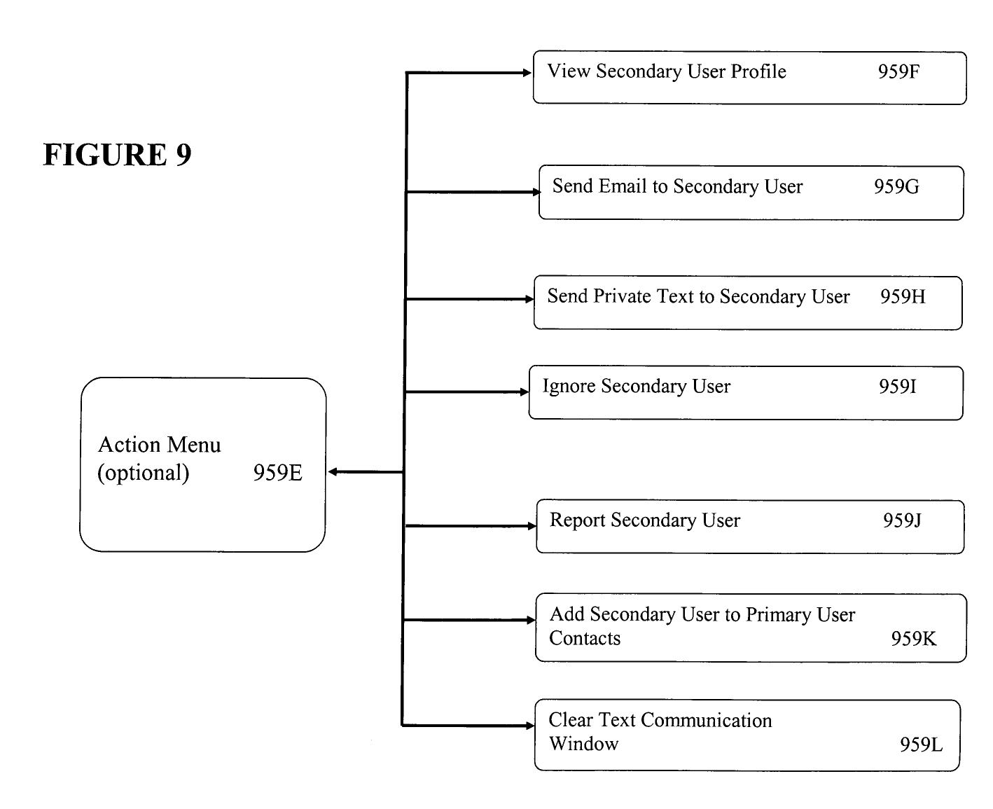

Additional aspects of the present invention will become evident upon reviewing the non-limiting embodiments described in the specification and the claims taken in conjunction with the accompanying figures, wherein like reference numerals denote like elements.

### DETAILED DESCRIPTION OF THE PREFERRED EMBODIMENT

Systems and methods in accordance with various aspects of the present invention provide a system and method for interpersonal communication over a global computer network especially adapted for interpersonal communication. In this regard, the present system may be described herein in terms of functional block components, various processing steps or interfaces. It should be appreciated that such functional blocks may be realized by various hardware, firmware, and/or software components configured to perform the specified functions. For example, the present system may employ various software, algorithms, subroutines, circuitry, electronics and software subroutines such as microprocessors, microcontrollers, integrated circuit components, memory elements, digital signal processing elements, look-up tables, databases, and the like, which may carry out a variety of functions under the control of one or more processors or other control devices or control applications. Such general techniques and components that are known to those skilled in the art are not described in detail herein, but remain within the spirit, and the scope, of the present invention.

The present invention generally includes client software and server software programs residing on one or more host computing systems which are adapted to enable one or more users to broadcast or transmit video and audio data to an application server, which in turn rebroadcasts or transmits the data to other users accessing the present invention. As is known in the art, client software is typically a flash application program that may be downloaded to an end-user's computer for operation on the end-user's computer. Similarly, the server software is a centralized application or program that resides and runs on a dedicated computing system, such as a server, which is in communication with a network such as the Internet. While the typical client software runs from the end-users computer it nevertheless is adapted to communicate with the server software.

In particular, the present invention includes software components which are accessible by each user, each component adapted to run independently or concurrently with one or more of the other components. Thus, for example, a representative host computing environment may include an application host server or other computing system which stores, maintains and operates the present invention. A exemplary host computing system includes one or more microprocessors, for instance, for processing data, and a memory or storage unit for storing data coupled to each processor. Embodiments of the present invention may also include a display coupled to the microprocessors and a plurality of databases (e.g., stored on the storage unit). These databases may include user data, server data and/or (any combination of one or more) like data that could be used in association with the present invention.

For clarity, the primary user of the present invention is referred to as a “primary user”, and any secondary user of the present invention is referred to as a “secondary user”; of course, those of skill in the art will realizes that a primary user is easily interchangeable with a secondary user, and thus, the terms “primary” and “secondary” are only used relatively and without reference to any particular order or hierarchy.

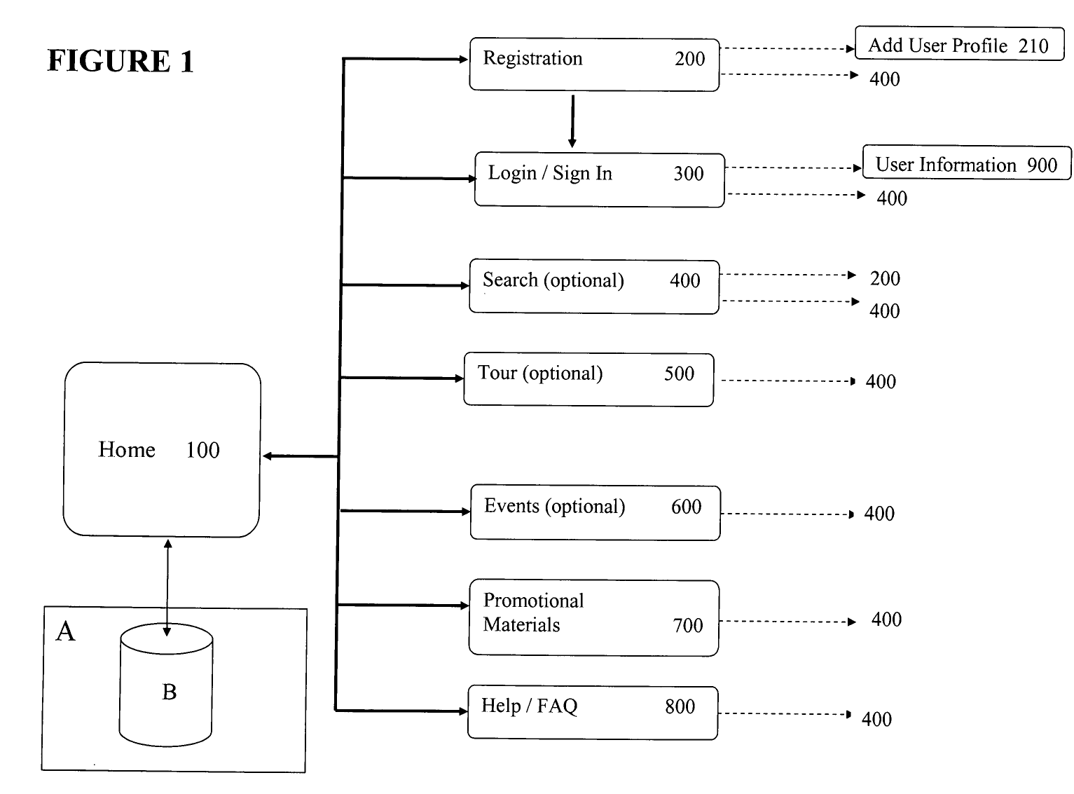

FIG. 1 illustrates an exemplary process flowchart for one or more representative processes or steps according to one aspect of the invention. The present invention is adapted to allow one or more users to access a home page or site 100 (or, home web page) from a computing system A, the home site being the initial portal to access the novel features of the present invention. From the home page 100, the present invention provides a user with several optional features or steps from which to choose, including whether the user would like to register to access the present invention 200, login or sign in to access the present invention 300, optionally search the informational database included in the present invention 400, optionally tour or view the features of the present invention 500, view any events hosted by the proprietor or operator of the present invention 600, view any promotional materials provided by the proprietor or operator of the present invention 700, and/or view the help database or view the Frequently Asked Questions (FAQ) 800. Each of these processes will be described more fully herein. Additionally, those of skill in the art will realize that any of these steps, functions or hyperlinks to perform such steps, may be displayed on the home page portal in any number of different configurations, shapes, and/or positions on the home page, yet still remain within the spirit and the scope of the present invention.

According to one aspect of the present invention, as seen in FIG. 1, the present invention is adapted to allow a user to select whether to register to access the present invention 200 over a computer network (e.g., such as the Internet) from the home page 100 through a conventional Internet web browser (e.g., such as Microsoft Internet Explorer). A primary user must first complete the registration process prior to being allowed to access the present invention. In one embodiment, the registration process encompasses at least a database on the computing system which stores responses entered by each primary user, such as, for example, information concerning the primary user's perceived personality, locality, interests and other data. Once the present invention receives the registration data from the user, the registration data may be stored in a user information database for future use (illustrated as “B”, for example, in FIG. 1). From registration step 200, the present invention may also be adapted to allow a user to either add another user profile 210, or perform an optional search of the information database 400. Alternatively, from registration 200, and once registration is verified and completed through Login interface 300, the present invention is then adapted to display the Primary User Information interface 900.

Those of skill in the art will realize that a representative computing system A may further include a processor for processing digital data, storage memory B coupled to the processor for storing data, at least one input coupled to any processor for inputting data, at least one server application program and at least one client application program stored in memory and accessible by the processor for processing the data, at least one display coupled to the processor and memory for displaying information derived from the data processed and at least one database storable in memory.

A variety of conventional communications media and protocols may be used for a network as disclosed herein, such as, for example, a connection to an Internet Service Provider (ISP) over a local loop as is typically used in connection with standard modem communication, cable modem, dish network, ISDN, Digital Subscriber Line (DSL), or various wireless communication methods. A representative network may also include a local area network (LAN) which interfaces to a network via a leased line (T1, D3, etc.) and managed by a TCP/IP protocol. Such communication methods are well known in the art, and are covered in a variety of standard texts.

According to another aspect of the present invention, as seen in FIG. 1, the present invention is adapted to allow a user to select whether to login or sign in to access the present invention 300 from the home page 100. This option is employed by users who have previously completed the registration process 200. If selected by the user, the login process 300 is adapted to receive information from the new user, such as the primary user's user identification and password. From login step 300, the present invention may also be adapted to allow a user to either perform an optional search of the information database 400, or, once login information is verified and complete, the present invention may then be adapted to display the Primary User Information interface 900.

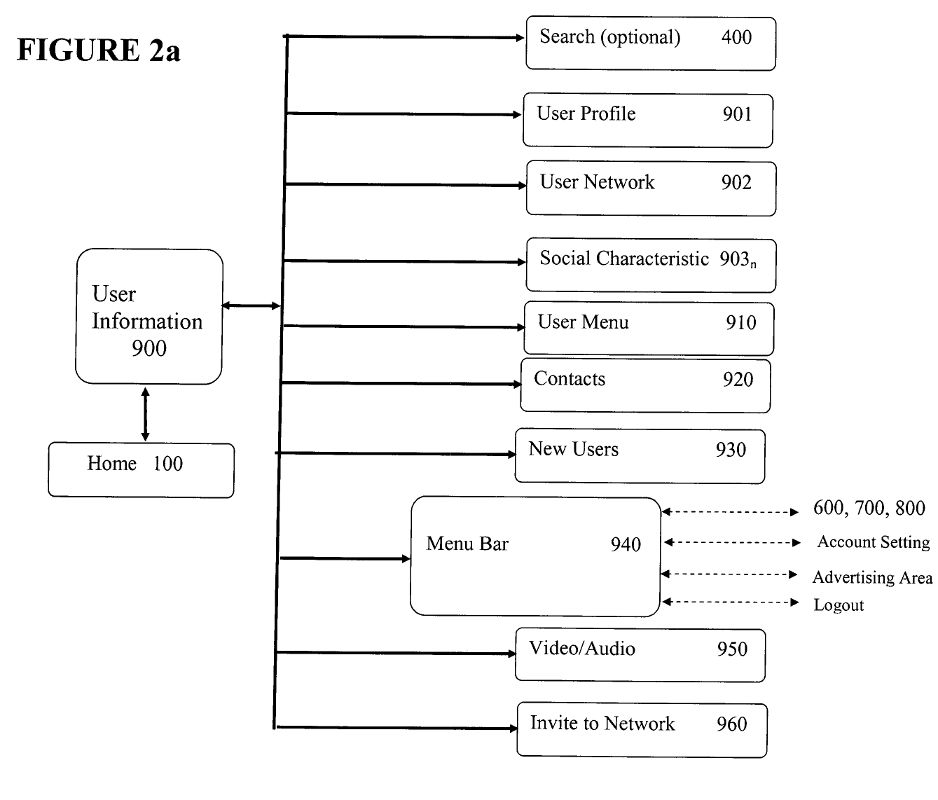

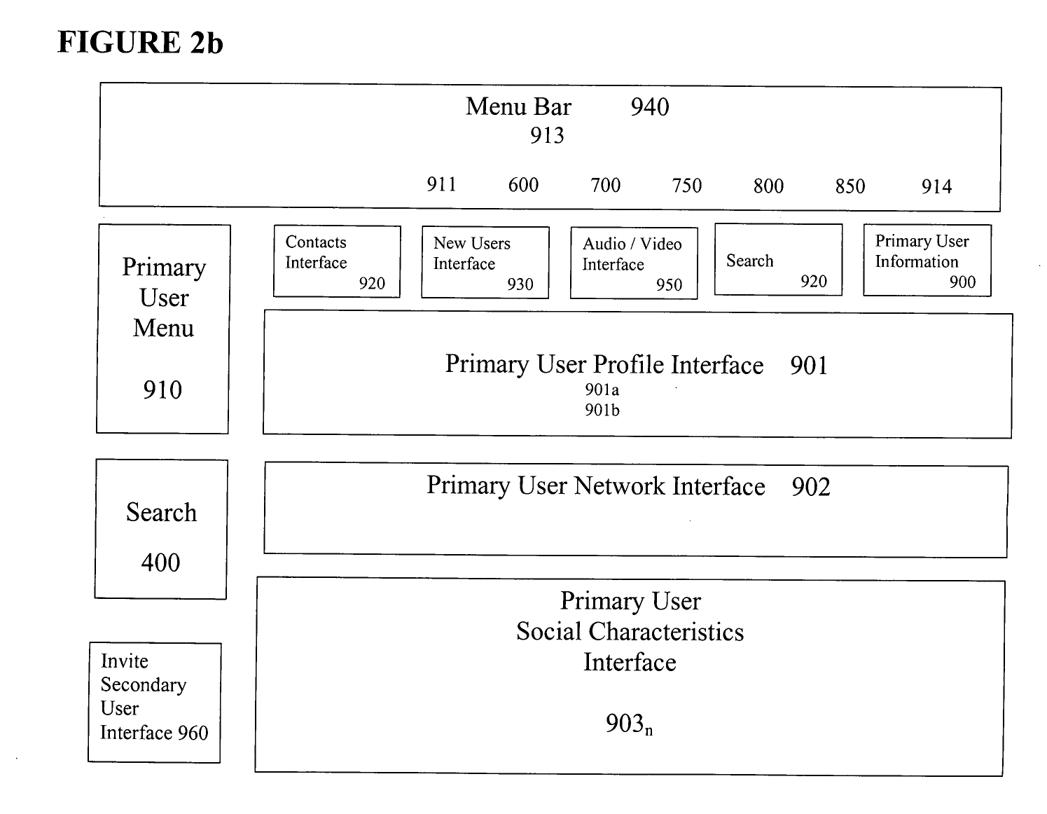

Once the registration or login process is complete, the present invention is adapted to allow a registered user to enter the Internet web site and display the User Information interface 900. As seen in FIGS. 2a and 2b, Primary User Information interface 900 may be adapted to concurrently display information about the user which was previously provided to and stored by the present invention by the user through Registration 200. The Primary User Information interface 900 is preferably adapted to provide a single location or interface which displays all user characteristics entered by the user, where such user characteristics may be used by the search features or search engine of the present invention, or may be subsequently modified by the user. Thus, for example, as seen in FIG. 2a, the Primary User Information interface 900 may be adapted to conveniently display all features available to a user as described throughout this disclosure, such as an optional Search interface 400, a User Menu interface 910, a Contacts interface 920, a New Users interface 930, a Menu Bar interface 940, a Video/Audio interface 950, or any predetermined combination of the foregoing.

As seen in FIG. 2b, the Primary User Information interface 900 may also be adapted to display a brief identification of the primary user through a Primary “User Profile” interface 901 (which may briefly identify, for example, the user's pre-selected icon, photograph or picture, the user's age, the user's gender, the user's location, or the user's desire for interpersonal communication with secondary users of the present invention, all information previously entered by the primary user and electronically stored by the present invention). The Primary User Profile interface 901 is partially or exactly the same information that may be displayed to secondary users if desired by the primary user. Thus, the primary user may “see” their own profile of what a secondary user will “see”, and accordingly, may change or modify any of the data within the Primary User Profile interface 901 to achieve a desired view or purpose.

Optionally, the Primary User Profile interface 901 may include a hyperlink 901a which allows a primary user to determine which secondary user(s) have added the primary user's data or contact information to the secondary user's contact list. Upon selection of the optional hyperlink, the present invention displays by name, and optionally by picture, each secondary user which has added the primary user to their contact list. In this regard, the primary user may then be able to selectively communicate with, or view data from, any secondary user who has shown an interest in the primary user based on the Primary User Profile interface 901.

The Primary User Profile interface 901 may further feature an optional hyperlink to a messenger interface 901b (illustrated for example in FIG. 2b) which will allow a primary user to communicate on a one-to-one basis with one or more secondary users who are also concurrently accessing any feature of the present invention. Thus, in one embodiment, the communication method may be by text chat. In another embodiment, a primary user may only communicate with only those secondary users who have been placed on the primary user's Contacts interface 920. If the secondary user is accessing the present invention, the present invention will receive the primary user's text message and redirect it to the secondary user so that the secondary user will be notified of the primary user's text message. If the secondary user is not accessing the present invention, the primary user will be notified upon attempting to send the message to the secondary user that the secondary user is not accessing the present invention. The messenger interface 901b compliments the present invention's video features in many ways. For example: if a primary user is trying to locate another secondary user who is accessing the present invention, but can't immediately locate the secondary user, the primary user could use the messenger interface 901b to attempt to contact the secondary user and ask textually “where are you?” or “meet me in my private room”.

As further illustrated in FIG. 2b, the Primary User Information interface 900 may also be adapted to communicate with a Primary User Network interface 902. Network interface 902 is adapted to display one or more secondary user icons (such as the secondary user's pre-selected icon, photograph or picture, for example) which correspondingly link to the secondary user's Primary User Profile interface. Thus, when a primary user decides to add a secondary user's icon to the Primary User's Network interface 902, the present invention allows the primary user to easily view the secondary user's profile every time the User Information interface 900 is accessed, and as described further below, allows the primary user to view the secondary user's network of users as well. In this fashion, this communication process functions similar to physical networking, thereby allowing the primary user to exchange information, communication and data among one or more secondary users, without having to contact the secondary user. Thus, not only will the primary user view the secondary user's profile, the primary user may also view the secondary user's own network of other secondary users (or, users which may typically encompass friends, family, colleagues, or the secondary user's interpersonal interests).

Optionally, the Primary User Network interface 902 may allow (through a hyperlink, for example) the primary user to determine whether their own primary network of friends is visible to other users on the network via interface 901b. Thus, the present invention allows the primary user to determine whether the primary user's network of secondary users can be displayed if desired by another secondary user (who is, for example, unknown to the primary user). This option might be useful if the primary user is concerned about security for their friends who are allowed by the present invention to access this invention, for example, or because the primary user does not want to reveal their friends, family or other interpersonal relationship contacts to any unknown secondary user.

The Primary User Information interface 900 may be further adapted to provide a more comprehensive identification of the primary user through one or more Social Characteristic interfaces 903₁ through 903ₙ (where n=1, 2, 3, . . . etc.). Thus, in one representative example, Social Characteristic interface 902ₙ may be adapted to display information (preferably, in text) about the user's physical and social inclinations, such as self-perceived confidence level, desired interpersonal communications, height, hair color, eye color, body type, ethnicity, religious preferences, education level achieved, occupation, income level, drinking behavior, smoking behavior, marital status, existing children or perceived desire to have children. As another example, Social Characteristic interface 903ₙ may also be adapted to display information about the user's perception of his or her personality, including (but not limited to) an ideal place to reside, the person's personal hygiene or housekeeping habits, work habits, favorite types of music or types of activities or hobbies enjoyed by the user. In still another representative example, Social Characteristic interface 903ₙ may be adapted to display information about the primary user's desires concerning interpersonal contact with other users (or, secondary users) accessing the present invention, including the type of person desired, the height, hair color, eye color, body type or ethnicity of the person desired for interpersonal communication, and may also include the user's desires concerning the other user's education level, occupation, income level and drinking or smoking behavior. As another example, Primary User Social Characteristic interface 903ₙ may be adapted to display information about the primary user's desires concerning the primary's user's specific interpersonal contact desires (e.g., “turn ons”) or non-desires (e.g., “turn offs”). Additional known social or personal characteristics may be added or removed from the present invention, and again, any or all of this information may be used in conjunction with the search features of the present invention.

As also seen in FIGS. 2a and 2b, the User Information interface 900 may also be adapted to communicate with or access an optional search engine of the information database 400, access a User Menu interface 910, access a Contacts interface 920, access a New Users interface 930, access a Menu Bar interface 940, access a Video/Audio interface 950 or access an Invite to Network interface 960. An exemplary graphical user interface, illustrating process placement within a graphical user interface, is shown in FIG. 2b.

It should be appreciated that the particular implementations shown and described herein are illustrative of the invention and its best mode, and are not intended to otherwise limit the scope of the present invention in any way. Indeed, for the sake of brevity, conventional data networking, application development and other functional aspects of the systems (and components of the individual operating components of the systems) may not be described in detail herein because such information is known in the art. Furthermore, the connecting lines shown in the various figures contained herein are intended to represent exemplary functional relationships, spatial relationships and/or communication couplings between the various elements. It should be noted that many alternative or additional functional relationships or physical connections may be used.

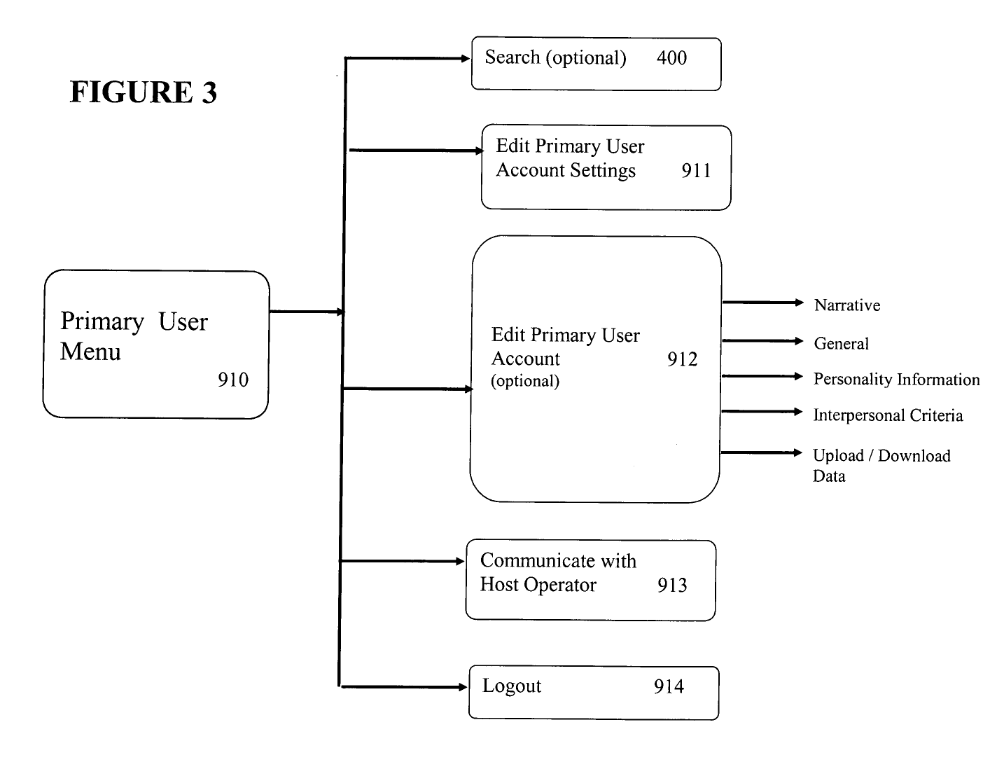

FIG. 3 illustrates a representative Primary User Menu interface 910 which can be displayed on any of the web pages utilized by the present invention for convenience of the primary user, and preferably is displayed as a static frame on any web page. The term “static” means that preferably, the interface does not change position or text (unless modified by the operator) so that it consistently appears in the same relative location on a computer monitor or viewing device, no matter which web page is being viewed. The Primary User Menu 910 is preferably adapted to allow a primary user to easily communicate with and access a Primary User Account Settings interface 911, access an Edit Primary User Account interface 912, communicate with the Host Operator interface 913 or Logout of the present invention 914.

Thus, in one embodiment, when the Primary User Account Settings interface 911 is accessed from the Primary User Menu 910, the primary user is then allowed to enter, modify or set any information relating to the primary user's account, such as email address, password replacement, search engine defaults, mobile phone provider and contact information such as telephone numbers. Of course, those of skill in the art will realize that the present invention may be adapted to selectively hide any of this information from the present invention's search engine capabilities if desired by the primary user. If the Edit Primary User Account interface 912 is accessed, the primary user may then be allowed to enter, modify or set any information relating to the primary user's social characteristics (which are displayed through the Primary User Social Characteristics interface 902ₙ). Thus, for example, the primary user may edit their narrative, general information, personality information, or interpersonal criteria information, and may also upload or download specified information such as digital pictures. Further, if the primary user desires, the present invention will allow the primary user to communicate with the Host Operator interface 913 by electronic mail or other means, which may allow the primary user to ask questions about the present invention or provide communication feedback to the host operator. Finally, the Edit Primary User Account interface 912 is adapted to allow the primary user to select Logout 914 to logout or cease use of the present invention, thereby returning to the Home page interface 100.

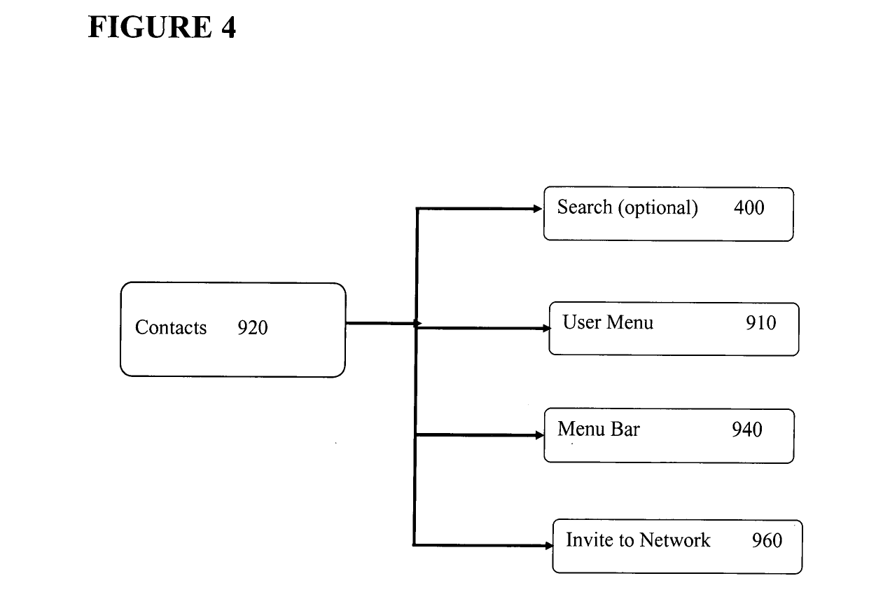

Turning now to FIG. 4, the Contacts interface 920 of the present invention, when accessed, is adapted to allow a primary user to communicate with an optional search engine of the information database 400, access a User Menu interface 910, access a Menu Bar interface 940 or access an Invite to Network interface 960. Like the Network interface 902, the Contacts interface 920 of the present invention is adapted to display one or more secondary user icons (such as the secondary user's photograph, for example) which, when selected by the user, correspondingly link to the secondary user's Primary User Profile interface. Thus, not only will the primary user view the secondary user's profile, the primary user may also subsequently view the secondary user's own network of other secondary users (or, users which may encompass friends, family, colleagues, or interpersonal interests). Thus, one of skill in the art will realize that for each new secondary user profile viewed, there many be hyperlinks to additional networks of secondary users in which to view, all within the same community base of the present invention. And, like several of the other interfaces discussed in this disclosure, the Contact interface 920 may be displayed on any of the web pages utilized by the present invention for convenience of the primary user, and preferably is displayed as a static frame which does not change position or text (unless modified by the operator).

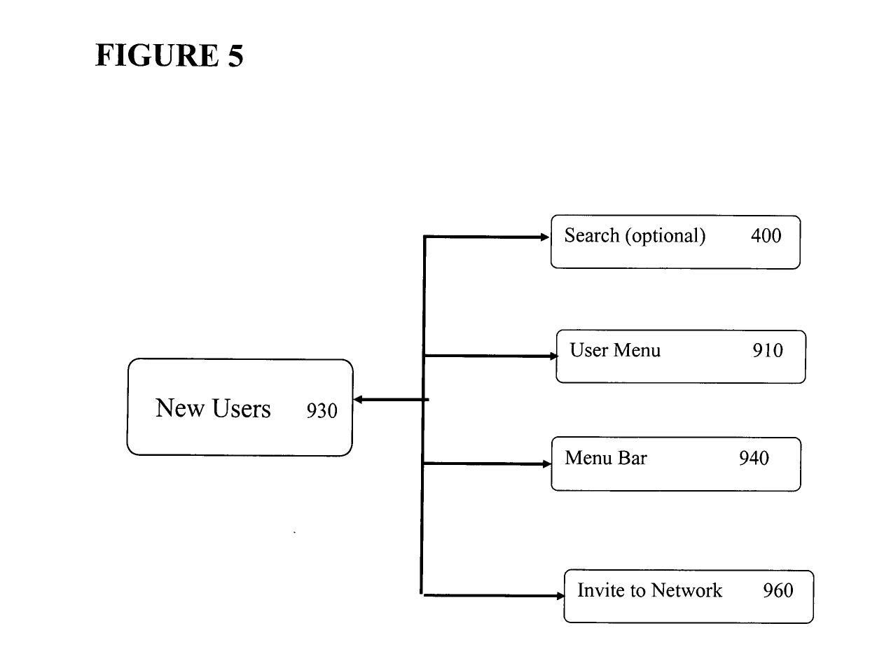

Turning now to FIG. 5, the New Users interface 930 of the present invention, when accessed, is adapted to allow a primary user to communicate with an optional search engine of the information database 400, access a User Menu interface 910, access a Menu Bar interface 940 or access an Invite to Network interface 960. The New Users interface 930 is preferably adapted to display one or more icons (such as a photograph) and user names of the most recent users who completed the registration step 200 of the present invention. Because of the popularity of the present invention, the New Users interface 930 may be adapted to display one or more hyperlinks which are linked to additional display pages containing a similar display of newer users. Like several of the other interfaces discussed in this disclosure, the New Users interface 930 may be displayed on any of the web pages utilized by the present invention for convenience of the primary user, and preferably is displayed as a static frame which does not change position or text (unless modified by the operator). The New Users interface 930 allows existing users to expand their network of friends or interpersonal relationships.

Returning to FIG. 2b, for example, the Menu Bar interface 940 of the present invention may be displayed on any of the web pages utilized by the present invention for convenience of the primary user, and preferably is displayed as a static frame which does not change position or text (unless modified by the operator). When utilized, the Menu Bar interface 940 is adapted to allow a primary user to access the Primary User Account Settings 911, access an optional Events interface 600, display optional Promotional Materials interface 700, display a Success Stories interface 750, display a Help or Frequently Asked Questions interface 800, access the Logout 914 feature of the present invention, display an Advertising Area or banner as desired, or will allow the primary user to contact the host operator 913. Of course, any of these interfaces may be deleted, or additional interfaces added. Preferably, the Menu Bar interface is displayed on any web page in a location readily visible to the primary user, such as in the upper portion of the web page as seen in FIG. 2b.

In one embodiment, the Menu Bar interface 940 of the present invention also communicates and has access to a Mobile Communication interface 850 through an appropriate hyperlink. When accessed, the Mobile Communication interface 850 allows a user to register for an additional feature of the present invention which will allow the user to access the present invention through use of a mobile communication device (such as, for example, a mobile phone, personal digital assistant or “PDA” or like remotely-located communication device) to access the features of the present invention, without any use of a computer terminal or hard wired network. In this embodiment, a user may then use their mobile communication device to access the present invention wirelessly. When used in this fashion, the user may then send text email messages to secondary users, utilize the search features of the present invention, view secondary user profiles and photographs, and check for any new messages. This feature allows a primary user to interface with the present invention at any time, and almost at any place where mobile communication is available.

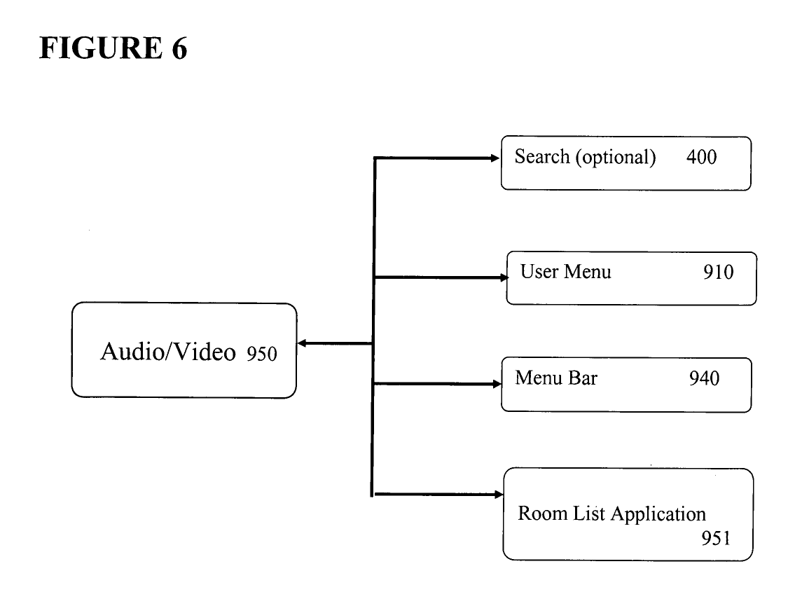

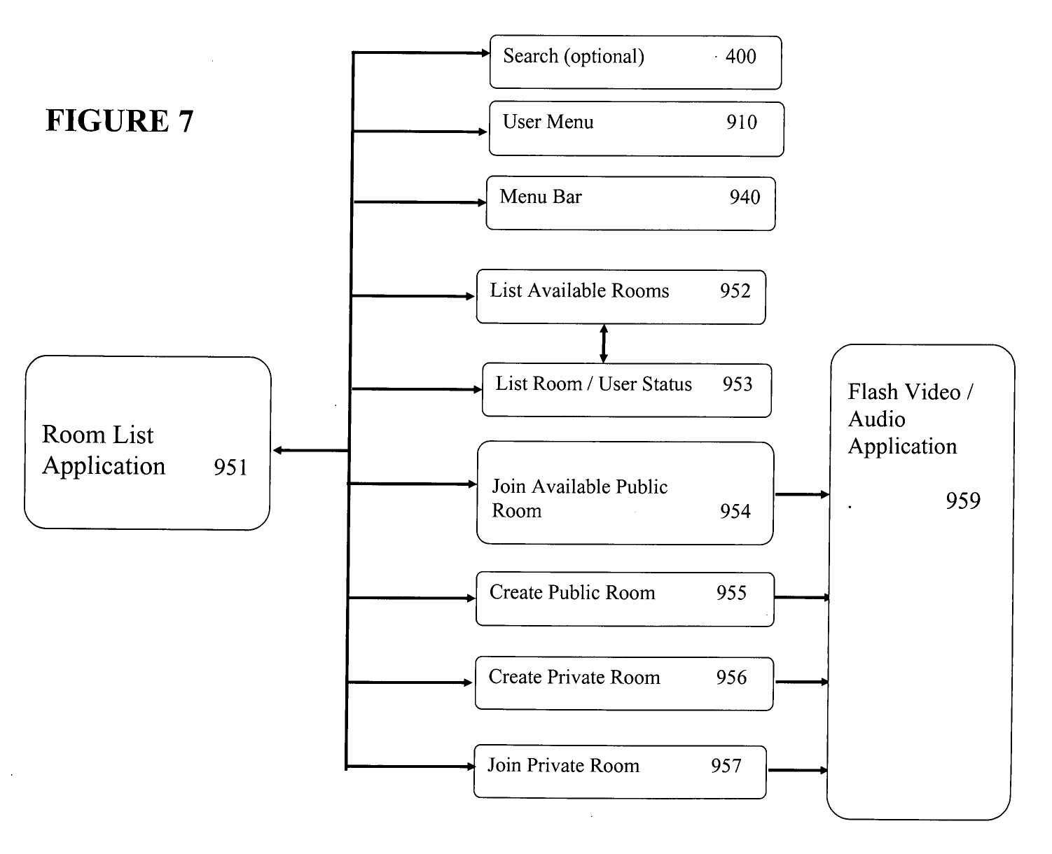

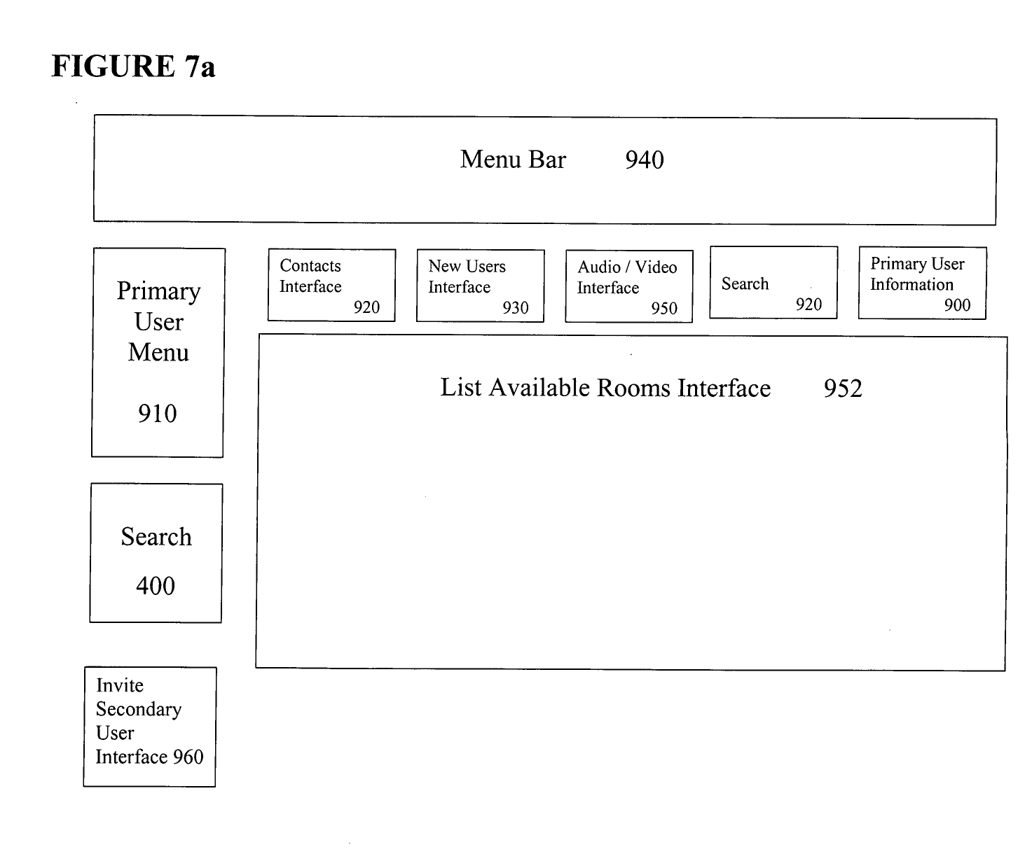

Turning now to FIG. 6, the Audio/Video interface 950 of the present invention, when accessed, is adapted to allow a primary user to communicate with an optional search engine of the information database 400, access a User Menu interface 910, access a Menu Bar interface 940 or may access a Room List Application 951. Those of skill in the art will realize that the Audio/Video interface 950 of the present invention may be placed on pre-selected Internet web pages within the present invention to optimize the primary user's convenience (such as seen, for example, in FIG. 7b).

As seen in FIG. 7, when the Room List Application 951 is accessed, it may be adapted to allow a primary user to communicate with an optional search engine of the information database 400, access a User Menu interface 910 or access a Menu Bar interface 940. The Room List Application interface 951 is adapted to provide an entryway into one or more “virtual rooms” which may be available to the primary user according to the present invention, and more precisely, is adapted to display information about each room created. Within each virtual room, the primary user may communicate with one or more secondary users who are accessing the present invention. In this regard, the Room List Application 951 may also be adapted to allow the primary user to access a List Available Rooms interface 952, List Room/User Status interface 953, Join Available Public Room interface 954, Create Public Room interface 955 or Join Private Room 956. Thus, for example, an representative graphical user interface, illustrating step or process placement within a graphical user interface, is shown in FIG. 7a.

The List Available Rooms interface 952 is adapted to display a list of virtual rooms created by primary users, secondary users or the host operator. In one embodiment, the List Available Rooms interface 952 is adapted to display a pre-selected number of virtual rooms within a limited viewing area, with a conventional vertical or horizontal scroll bar controlling the viewing area to display additional virtual rooms. In another embodiment, the List Available Rooms interface 952 is adapted to display not only the name of a particular virtual room, but also how many users are within the virtual room, thereby allowing the primary user to determine whether to enter (or, join) the room or not. In still another embodiment, the List Available Rooms interface 952 is adapted to dynamically display the number of users accessing the present invention, or may dynamically display the number of rooms created by the users of the present invention (“dynamically” refers to real time data updates, which does not require the user to refresh or re-display the web page in their web browser). The present invention is adapted to provide real-time video or real time audio transmission and/or communication without having to refresh a user's web browser because the video application and the audio application are client software computer programs adapted to send and receive data in real time communication with the server software.

The present invention allows the primary user to perform one of several tasks when accessing the List Available Rooms interface 952. For example, the present invention will allow a user to join an available (or, already created) public room by selecting the Join Available Public Room 954 interface, create a public room by selecting the Create Public Room 955 interface, create a password-protected private room by selecting the Create Private Room 955 interface, or join an existing private room by selecting the Join Private Room interface 956 and entering the correct password for access. Once any of these interfaces are selected through a corresponding hyperlink, the present invention is adapted to display the Flash Video/Audio Application interface 959 corresponding to such selections, which is described further below.

Thus, as an example, the present invention displays a Join Available Public Room interface 954. Once a public room is created by a user, it is available for all users accessing the present system as long as adequate system resources are present (such as, for example, adequate memory or adequate bandwidth for transmission of data). If a primary user is interested in joining one of the public rooms listed in the List Available Rooms interface 952, the present invention is adapted to allow the user to first select or highlight the desired room identifier shown in the List Available Rooms interface 952 and select the Join Available Public Room interface 954. From this sequence, the present invention will then display the Flash Video/Audio Application interface 959.

Optionally, adjacent to the List Available Rooms interface 952, but still a part of the List Available Rooms interface 952, is the List Room/User Status interface 953. The List Room/User Status interface 953 is adapted to display brief information regarding the number of rooms currently created (such as the total number of rooms), the names of each room available (as dictated by the room's creator), whether the rooms are publicly available or not, as well as the total number of users accessing the rooms. This interface provides convenient information to the primary user in determining the activity level of the present invention. The List Room/User Status interface 953 may also be adapted to, for the room highlighted or selected, display the total number of women who are accessing the present invention, as well as the total number of men accessing the present invention, as well as display whether the room is a publicly available room or a private, password-protected room. In one embodiment, the men accessing the present invention may be designated by a certain font color or icon (such as, for example, the color blue, or a graphical icon of a male), and similarly, the present invention may designate women users by pre-selected font color or icon (such as, for example, the color pink, or a graphical icon of a female).

It should be noted that the present invention is particularly beneficial to meet the needs of female users who require more control over the online dating experience. By integrating the disclosed privacy and screening tools into several aspects of the present invention (such as the video chat interface), women users can better control the interpersonal communication experience and dictate when and how they interact with other members, whether male or female. In any event, the present invention allows all users to launch a private, password-protected video/audio room with any other member. The present invention preferably features security algorithms to preserve the privacy of users which can prevent unauthorized access to a private room. Thus, for example, the present invention may employ privacy switches which allow a primary user to prevent any pre-selected secondary user from accessing a private room, whether by audio, by video, or both. The present invention may also employ one or more secondary user disabling algorithms which prevent an unwanted secondary user from accessing a primary user's private room, and may also employ at least one host operator communication algorithm which allows a primary user to report a secondary user's inappropriate behavior.

Returning now to FIG. 7, the Flash Video/Audio Application interface 959 may be accessed by a primary or secondary user by any pre-selected web page within the present invention, such as, for example, the Join Available Public Room interface 954, the Create Public Room interface 955, the Create Private Room interface 956 or the Join Private Room interface 956.

The Flash Video/Audio Application interface 959 is preferably the entry point or portal into the real time audio and/or video capabilities of the present invention. It is from the Flash Video/Audio Application interface 959 that a user can view other user data streams, broadcast his/her own data stream, send and receive text messages and perform other user actions (so that each action allows exchange of data between the user and any other users). The software program that controls the operation of the Room List Application interface 951 and the Flash Video/Audio Application 595 as described further below is preferably written in the flash programming language and residing on at least one computing system. The flash programming language is available, for example, through Macromedia at http://www.macromedia.com/software/flashcom. “Flash” is known in the art as an Internet web browser plug-in (similar to Java) that enables embedded flash applications to run or operate within any web browser so long as that browser supports the flash plug-in or has the flash plug-in installed. In one recent embodiment offered by Macromedia, the flash programming language is embodied within a software program titled “Macromedia Flash Communication Server MX”, which is a server based software program allowing a programmer to create interactive web-based audio/video applications such as video on demand, live event broadcasts, webcam chat, and real-time collaboration applications.

As noted previously, the software program may comprise up to two components: the client application program (which controls the display on a user's viewing monitor, such as the plug-in) and the server application program (which communicates with the client application program and controls or manages the client application program). The client application program is preferably a flash plug in driver, capable of operation on or in conjunction with a user's Internet web browser program. The client application program is preferably adapted to control all visual elements displayed to a user and responding to any user command. Upon the selection of a user command, the client application program communicates with the flash communication server to transmit data (e.g., audio, video, or text). It is preferred that the client application program be in constant or simultaneous communication with the flash communication server to achieve the real time data streaming according to the present invention. If the client application program should be disconnected from the flash communication server for any reason, the client application program for the affected user(s) will stop or cease operation, and an error message will be displayed.

The server application program may include three components, namely, a flash room list application, a flash video room application and a flash communication video server application.

Accordingly, any action performed by the primary user in the Room List Application interface 951 or the Flash Video/Audio Application interface 595 will be communicated to the server application program through a network, and executed by the computing system. The server application program will then, in turn, execute the requested action and communicate with the user's viewing monitor and update the display accordingly through the client application program. Thus, for example, if a primary user selected to join a public room from the Join Available Public Room interface 954, the client application will transmit this instruction to the appropriate computing system, which will then control the primary user's view monitor to display any streaming audio, video and/or text data relating to the selected room. Also, for example, once a user enters the Flash Video/Audio Application interface 959, the computing system will make a constant communication connection with the user's viewing monitor (through the flash plug-in, for example) to thereby display substantially simultaneous video, audio and/or text communication. Clearly, the computing system is also programmed to store and maintain information relevant to each user who is accessing the present invention, the status of each user or their corresponding profile or data streams, and also any actions performed.

The Flash Video/Audio Application interface 959 is adapted to allow a primary user to visually see and, or, communicate by audio with, secondary users who are accessing a virtual room created within the present invention, all for the purpose of forming a “dating community” or “interpersonal communication community”. To obtain the full experience of both real time video and audio streaming, it is recommended that each user (primary or secondary) have a personal computer or computing means coupled to, or in communication with, a web camera and/or microphone. In another embodiment, it is recommended that a mobile communication device accessing the present invention remotely be in communication with a camera (such as a built-in cellular phone camera) and a microphone. The present invention will allow users to enter, create and/or communicate with the present invention through their computer or mobile communication device without a web camera, but, without a camera, the primary user cannot broadcast images or video (such as of themselves). Those of skill in the art will realize that while the term “camera” is used, this term not only relates to an apparatus or system that can take single, individual snapshots or pictures, but also to those systems capable of capturing and transmitting streaming video data at any bit rate or frequency.

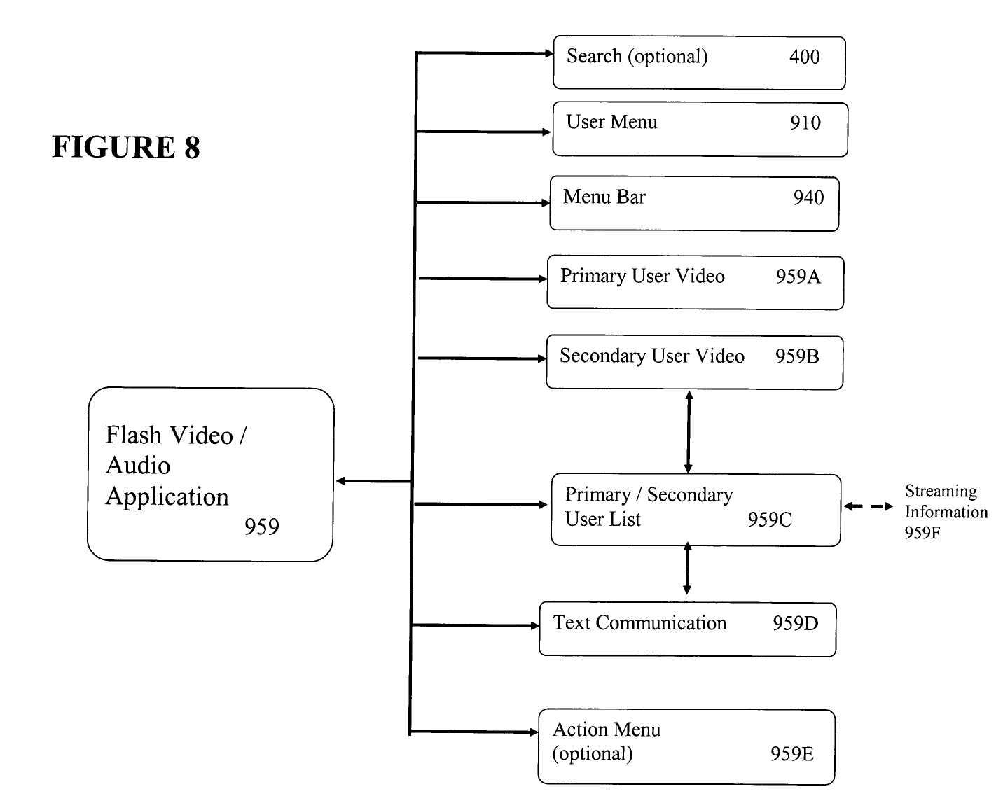

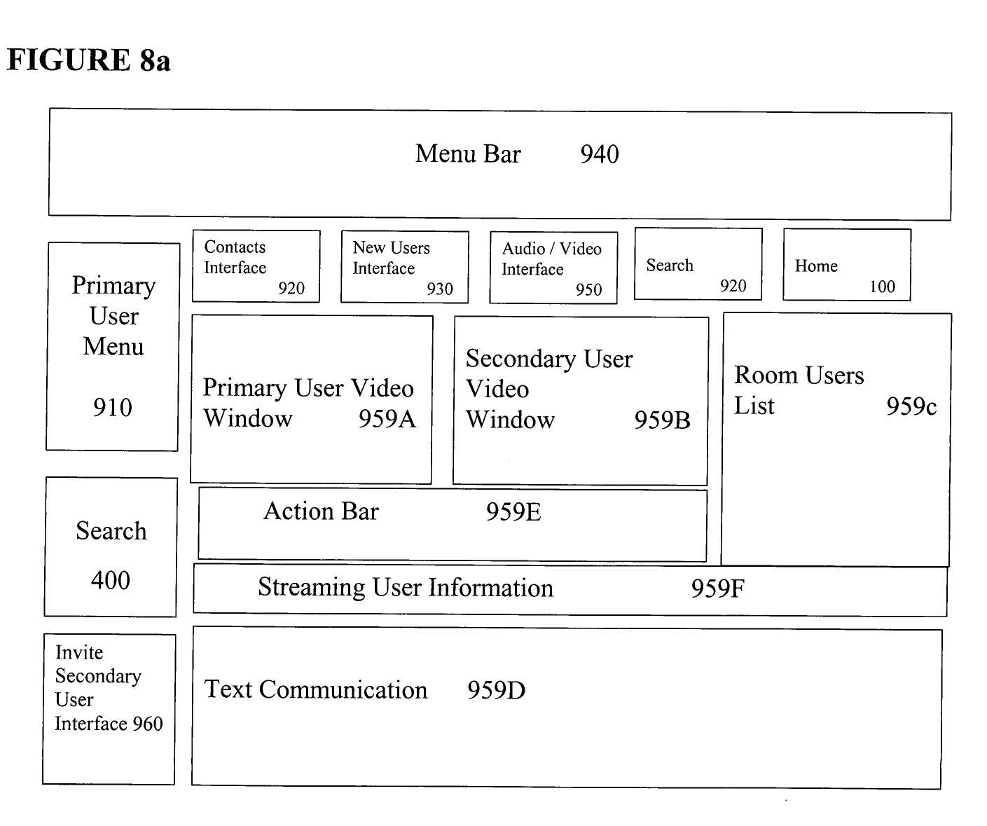

The Flash Video/Audio Application interface 959 is adapted to allow real time audio and video streaming over one or more data channels for interpersonal communication, which delivers to the user an instant-on, always-on experience. A representative Flash Video/Audio Application interface 959, illustrating step or process placement within a graphical user interface, is shown in FIG. 8a. As illustrated, the Flash Video/Audio Application interface 959 preferably includes a Primary User Video Window 959A, a Secondary User Video Window 959B, a Room Users List interface 959C, a Text Communication interface 959D, an optional Action Menu interface 959E or a Streaming User Information interface 959F. Of course, those of skill in the art will realize that any one or more of these interfaces may be deleted or added as desired. Thus, for example, the Flash Video/Audio Application interface may feature only the Secondary User Video interface 959C.

In one embodiment, the Primary User Video interface 959A is adapted to communicate with the server application program (through the client application program), and transmit and display, preferably in real time, the primary user's video or audio stream emitted from the user's camera. The flash communication video server application is adapted to create and maintain a corresponding video and audio data stream for each user accessing the present invention. The Primary User Video interface 959A is controlled by the flash video room application residing on a computing system over a network such as the Internet. Thus, the flash video room application controls a user's access to the Primary User Video interface 959A, and further, controls all video, audio or text data transmitted between the user and the computing system. If the primary user desires to view data from a different secondary user, upon commend, the flash video room application redirects the data being transmitted to the primary user from the newly selected secondary user. If the primary user does not have video stream capability (because, for example, the user lacks a camera) or does not have audio stream capability, Primary User Video interface 959A may be displayed as a blank screen, or alternatively, may display a sign corresponding to the lack of video stream (e.g., “No Camera Detected”, or “No Microphone Detected”).

Preferably adjacent to the Primary User Video Window 959A is the Secondary User Video Window 959B. The Secondary User Video interface 959B is preferably adapted to communicate with the server application program through the client application program, and receive and display in real time a secondary user's video stream emitted from the secondary user's camera. The Secondary User Video interface 959B is controlled by the flash video room application residing on a computing system over a network such as the Internet. If the secondary user does not have video stream capability (because, for example, the secondary user lacks a camera) or does not have audio stream capability, the Secondary User Video interface 9595B may be adapted to display a blank screen, may display the secondary user's picture or photograph previously stored by the present invention, or alternatively, may display a sign corresponding to the lack of video stream (e.g., “No Camera Detected”, “No Photo” or “No Microphone Detected”).

Within the context of the present invention, the video application adapted for use by any user provides features which enables live video and audio communication between users around the world. The video application utilizes existing off the shelf programming languages and server software to create an application that enables people to meet, talk and see each other over a global computer network such as the Internet.

The Room Users List interface 959C is adapted to display in real time all of the users currently within, or who subsequently access or leave, the selected virtual room, and allows the primary user to select a particular secondary user for audio and/or video communication. The Room Users List interface 959C is controlled by the flash room list application residing on a computing system over a network such as the Internet. Thus, for example, when a primary user selects or highlights the link to a secondary user within the Room Users List interface 959C, the flash room list application communicates with the flash video room application to thereby subsequently modify the primary user's web page to preferably display the secondary user's picture or photograph (if available) in the Secondary User Video interface 9595B, and then (or subsequently) maintain a stream of the secondary user's real time video and/or audio stream. The Room Users List interface 959C may also be adapted to designate the men accessing the current virtual room by a pre-selected font color or icon (such as, for example, the color blue, a graphical icon of a male, or like combination), and similarly, to designate women users accessing the selected virtual room by pre-selected font color or icon (such as, for example, the color pink, a graphical icon of a female, or like combination). Of course, other designations or icons may be utilized which correspond to, for example, each user's social characteristics (e.g., brunette, blond) or to each user's interpersonal desires (woman seeking man, man seeking man, etc.).

The Text Communication interface 959D is adapted to allow all users within the selected virtual room to conduct real-time text conversations with other users. Thus, Text Communication interface 959D is adapted to display a user interface in which a primary (or sending) user may type, transmit and send text messages to the remaining secondary (or, recipient) users in the selected virtual room, the text appearing in the interface almost instantly (or, in real-time). Messages appear in each user's interface 959D in time-dependant, alternating segments, following the flow of a natural conversation. Each text message that is posted by a user also appears in the Text Communication interface 959D with a visual or color identification (such as, for example, the user's identification or screen name) corresponding to who created or posted the text message. As the text within the Text Communication interface 959D reaches a predetermined maximum viewing limit within the dialog box, the Text Communication interface 959D is adapted to allow text scrolling (through, for example, a scroll bar).

Optionally, the Text Communication interface 959D may also be adapted to display emoticons, An emoticon or “emotional icon” is a textual or graphical expression of emotion, such a smile “:)” or wink “;)” that is suitable for instant messaging, which help compensate for the absence of intonation, body language, and other expressions of emotion that occur in other types of conversations. Obviously, in light of the present invention, the use of emoticons might be useful for those users who do not have a camera or video stream capability.

The optional Action Menu interface 959E is adapted to allow a primary user to perform predefined actions towards a selected secondary user identified in the Room Users List interface 959C. For example, the present invention may allow a primary user to first select one of the secondary users appearing in the Room Users List interface 959C. Then, the primary user is allowed to select the “View Profile” hyperlink within the Action Menu interface 959E, wherein a web browser window will launch or open up corresponding to the secondary user's previously stored profile (e.g., User Profile 901). The Action Menu may also be adapted to allow a primary user to send a private text message to the selected secondary user. When the “Send Private Message” option is selected, the present invention will open a dialog box for text input. After the primary user enters the text and sends the text through an appropriate button, the text message will subsequently appear only in the selected secondary user's Text Communication interface 959D.

The Action Menu interface 959E may also be adapted to allow a primary user to flirt with the selected secondary user by presenting to the primary user a list of pre-defined flirt text messages. When the primary user selects a pre-defined flirt text message, the user will then send the message through an appropriate hyperlink, and the text message will subsequently appear only in the selected secondary user's Text Communication interface 959D. Again, as described throughout this invention, any user action or command is communicated to the flash server, which in turn, communicates with the client software to control the user's viewing interface to allow real-time communication.

The Action Menu interface 959E may also be adapted to allow a primary user to ignore the selected secondary user by preventing communication from the secondary user to the primary user's Flash Video/Audio Application interface 959. The Action Menu interface 959E may also be adapted to allow a primary user to report or register a complaint against an offensive selected secondary user to the host operator. Additionally, the Action Menu interface 959E may also be adapted to allow a primary user to add the selected secondary user to the primary user's contact list, which is available for subsequent viewing through the Primary User Network interface 902. Moreover, the Action Menu interface 959E may also be adapted to allow the primary user who created the virtual room to boot, kick out, or ban a selected secondary user from the virtual room. This feature allows the primary user who created the room to moderate or selectively allow certain participants to access the room.

Streaming User Information interface 959F is preferably adapted to display a continuous, but scrolling text message to the primary user which corresponds to text from the selected secondary user's profile. As such, a primary user may select a name from the secondary user list 959c, and while viewing any video or hearing any audio transmitted by the secondary user, the primary user may also view the text associated with the secondary user's profile.

As will be clear to those of skill in the art, each of the foregoing actions or user-accessed hyperlinks is controlled by the server application program and the client application program, both executable and storable on one or more computing systems which communicate with each user accessing the present invention. Additionally, all data pertaining to the present invention (such as user name, profile text, passwords, created room lists, block requests, etc.) are stored on the computing systems, each computing system in secure communication with the others.

Thus, for example, if a primary user selects a different secondary user from the appearing in the Room Users List interface 959C, the computing system will control the user's viewing monitor to display substantially simultaneously data concerning the newly selected secondary user. As still another example, if the primary user is in a virtual room created by the primary user, the primary user can notify a secondary user to join the primary user in the private virtual room. In this regard, the computing system will notify the secondary user of the invitation to join the primary user's private room. If the secondary user desires to join the private room, the secondary user will transmit the appropriate password to the computing system for validation; if the password is correct, the computing system will allow the secondary user to join the primary user's private room. If the password is incorrect, the computing system will notify the secondary user of the incorrect password, and request retransmission.

Those of skill in the art will realize that conventional, off the shelf programming tools and applications may be used to create the appropriate algorithms disclosed in this invention. Thus, for example, one of skill in the art will now come to realize that the following tools and applications could be utilized, without undue experimentation, to achieve the novel features of the present invention: Httpd web server, flash MX programming language, flash communication service software, PHP server programming language and/or use of an appropriate Oracle database software.

PHP scripts are preferably used to relay data from the flash communication server to the client application program. There are typically two types of requests that require data communication with PHP. The first request is the user join request. When a user selects to join a virtual room, a unique key is read in from the web page on which the client application resides. The unique key is then passed to PHP, which evaluates relevant information about the user associated with that key. The data is then passed back to the flash application program from PHP in the form of a URI query string (key=value pairs). This information is then stored on the flash communication server upon connection. The second type of request is a Bad User report. This is a feature of the client application program, which will allow a user to report another user for improper conduct. When the user selects to report another user, the primary user fills out a short form in the client application program identifying the reason for the report. This data is then transmitted into PHP where it can be stored in the computing system for the host's administrative review. PHP scripts are also linked from the client application to provide other functions such as: adding user to contact list, viewing user profile, and sending the user email messages.

The Invite to Network interface 960 is optionally available to a primary user to allow the primary user to send an email message to another user at another email address not controlled by the present invention. The Invite to Network interface 960 is preferably adapted to allow primary users to “invite” users who have not accessed the present invention (e.g., such as other non-site users) to access the present invention. If the non-site user invited by the primary user decides the access the present invention and logs in as a user, the present invention is adapted to automatically update the primary user's Contacts interface 920 to now display the non-site user as a secondary user.

The dating video application of the present invention utilizes existing off the shelf programming languages and server software to facilitate an environment and program that instantly enables people to meet, talk and see each other. The present invention overcomes the obstacles known over the email-only communication status quo offered on other web sites which advertise themselves as a dating web site.

Many applications or uses of the present invention can be formulated. For example, one of skill in the art will appreciate that a primary user may communicate with the present invention through a computing system over a network such as the Internet, an intranet, an extranet, WAN, LAN, satellite communications, and/or the like. Representative computing systems may include a personal computer, network computer, workstation, minicomputer, mainframe, or the like running any operating system such as any version of Windows, Windows NT, Windows ME, Windows 2000, Windows 98, Windows 95, MacOS, OS/2, BeOS, Linux, UNIX, Macintosh OS, or any software platform capable of accessing data over the Internet. Moreover, although the present system is described herein as being implemented with TCP/IP communications protocols, it will be readily understood that it could also be implemented using IPX, Appletalk, IP-6, NetBIOS, OSI or any number of existing or future protocols. The present invention is preferably adapted only to run within Internet browsers that support the flash programming language or any associated plug-in modules. The Flash plug-in module is currently supported in all known browsers, including Microsoft Internet Explorer, Netscape Navigator, Opera, and Mozilla, for example.

Exemplary storage databases may further include look up tables, data tables or like data structures, and may be organized in any suitable manner. Each database may be any type of database, such as relational, hierarchical, object-oriented, and/or the like. Such general techniques and components that are known to those skilled in the art are not described in detail herein. It should further be understood that the exemplary process or processes illustrated may include more or less steps or may be performed in the context of a larger processing scheme. Furthermore, the various flowcharts presented in the drawing figures are not to be construed as limiting the order in which the individual process steps may be performed.

The software elements of the present invention may be implemented with any programming or scripting language such as C, C++, Java, HTML, XML, COBOL, assembler, PERL, or the like, with the various algorithms being implemented with any combination of data structures, objects, processes, routines or other programming elements. Further, it should be noted that the present invention may employ any number of conventional techniques for data transmission, signaling, data processing, network control, and the like.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

In various embodiments of the present invention, the computing system A may operate a suitable website or other Internet-based graphical user interface. In one embodiment, an Internet Information Server, Microsoft Transaction Server, or a Microsoft SQL Server, may be used in conjunction with a Microsoft operating system, Microsoft NT web server software, a Microsoft SQL database system, or a Microsoft Commerce Server. Additionally, components such as Access Sequel Server, Oracle, MySQL, Intervase, etc., may be used to provide an ADO-compliant database management system. The term “web page” or “web site” as it is used herein is not meant to limit the type of documents and applications that might be used to interact with the users of the present invention. For example, a typical website might include, in addition to standard HTML documents, various forms, Java applets, Javascript, active server pages (ASP), common gateway interface scripts (CGI), hypertext text markup language (HTML), extensible markup language (XML), dynamic HTML, cascading style sheets (CSS), helper applications, plug-ins, and the like.

It should further be understood that the exemplary process or processes illustrated may include more or less steps or may be performed in the context of a larger processing scheme. Furthermore, the various flowcharts presented in the drawing figures are not to be construed as limiting the order in which the individual process steps may be performed.

It should also be appreciated that the particular implementations shown and described herein are illustrative of the invention and its best mode, and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships, spatial relationships and/or physical couplings between the various elements. It should be noted that many alternative or additional functional relationships or physical connections may be used.

These computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

The foregoing description of the preferred embodiments of the invention has been presented for the purposes of illustration and description. Other variations and modifications of the present invention will be apparent to those of ordinary skill in the art, and is not limited except by the appended claims. The particular values and configurations discussed above can be varied, and are cited to illustrate particular embodiments of the present invention. It is contemplated that the use of the present invention can involve components having different characteristics as long as the principles disclosed herein are followed.

1. A computing system for providing interpersonal communication over a network, the system including at least one microprocessor in communication with at least one memory device and the network, the system further including a server software program adapted to communicate with a client software program, the server software program being stored on the memory device and operated by each microprocessor, the system adapted to: maintain and control a selectively accessible interpersonal web site located on the network; to selectively allow one or more users to access the interpersonal web site through an Internet web browser; and to enable a primary user to exchange interpersonal data with at least one pre-selected secondary user through the interpersonal web site in substantially real time, the interpersonal data including interpersonal video data, audio data and text data.

2. The computing system of claim 1, the server software program being in substantially simultaneous communication with the client software over the network to achieve substantially real time data communication.

3. The computing system of claim 2, the client software program being an embedded flash application adapted to operate in conjunction with the Internet web browser which is viewable on a viewing device.

4. The computing system of claim 3, the server software program being adapted to control the client software so as to be able to modify the primary user's viewing device and modify each secondary user's viewing device to respond to any command entered by the primary user or any secondary user.

5. The computing system of claim 5, the system further including at least a login interface adapted to selectively allow a user to access the system, and a video/audio interface adapted to communicate interpersonal video data streams between the primary user and each secondary user in substantially real time, the login interface and the video/audio interface both viewable on the primary user's viewing device, and both being in communication with the server software over the network.

6. A computer implemented method of facilitating interpersonal communication over a network, the method comprising in any order at least the steps of: facilitating data communication between a primary user having a first computing system and at least a secondary user having at least a secondary computing system, the first computing system being in interpersonal data communication with each secondary computing system over a network through a server computing system, the interpersonal data communication being at least substantially real-time communication of video data.

7. The computing system of claim 5, the interpersonal data communication being at least substantially real-time communication of audio data.

8. A method for facilitating interpersonal communication over a network, the method comprising the steps of: providing a computer system having at least one microprocessor and at least one memory storage device, the computer system being in communication with a computer network, the computer system adapted to maintain and control a web site selectively accessible on the computer network; allowing at least a primary user to access the web site; and allowing at least a secondary user to access the web site to achieve substantially real-time interpersonal communication with the at least primary user.
